(19) United States
(12) Patent Application Publication
(10) Pub. No.: US 2001/0021614 A1
(43) Pub. Date: Sep. 13, 2001

(54) Printed coated textile based on a polyolefin component

(76) Inventor: Bruno Loez, Henin Beaumont (FR)

Correspondence Address: YOUNG & THOMPSON, 745 SOUTH 23RD STREET 2ND FLOOR, ARLINGTON, VA, 22202

(21) Appl. No.: 09/758,207

(22) Filed: Jan. 12, 2001

Related U.S. Application Data
(60) Provisional application No. 60/201,746, filed on May 4, 2000.

(30) Foreign Application Priority Data
Jan. 12, 2000 (FR) 00 00360

(51) Int. Cl. B32B 5/02; B32B 3/00; B32B 9/00; B05D 3/12; B05D 1/36

(52) U.S. Cl. 442/59; 427/261; 427/365

(57) ABSTRACT

The invention relates to a coated textile having printed patterns, of the type comprising a textile underlayer forming a backing and combined with a coating layer formed from a film based on an olefin polymer or copolymer or a blend of olefin polymers or copolymers and on an elastomer, the said coating layer having printed patterns on its surface which is not bonded to the textile underlayer.

It also relates to a process for producing it.

It applies more particularly to the manufacture of printed coated tablecloths.

The present invention relates to printed coated textiles, in which the coating layer is polyolefin-based, as well as to a process for producing them.

Currently available printed coated fabrics, for example for the production of tablecloths or other articles in the field of tableware, generally have a coating layer of PVC (polyvinyl chloride) and/or halogenated polymers, particularly of fluoropolymers.

Nevertheless, these coated fabrics are not very flexible and have insufficient ageing resistance, becoming stiff and brittle but also sticky to touch. In particular, they have very poor weather and ultraviolet resistance.

Moreover, these fabrics exhibit poor resistance to food stains which remain more and more pronounced over time and become more and more difficult to remove. At the same time, they may lose their colours or their printing patterns, especially with cleaning or due to the effect of light, or may even give rise to yellowing.

Furthermore, these coated fabrics generally cannot be recycled, particularly because of the presence of halogenated components.

One object of the present invention is to provide coated textiles able to bear printed patterns or decorations, which can be used in particular in the field of tableware and do not have the abovementioned drawbacks.

Another object of the invention is to provide particularly flexible coated textiles which keep their flexibility with use or with storage, as well as with continual cleaning.

Another object of the invention is also to provide a coated textile having satisfactory “printability” characteristics allowing, in particular, the printing of patterns or decorations placed, which are resistant to ageing, particularly over time, with respect to light rays, cleaning, heat, etc.

Another object of the invention is also to provide a process for the production of such printed coated textiles which is simple and inexpensive.

For this purpose, the subject of the invention is a coated textile having printed patterns, characterized in that it comprises a textile underlayer forming a backing and combined with a coating layer formed from a film based on a polyolefin component and on an elastomer, the said coating layer having printed patterns on its surface which is not bonded to the textile underlayer.

The invention also provides a process for the production of the above printed coated textile, characterized in that:

the process starts with a textile underlayer forming a backing;

a coating layer, based on a polyolefin component and on an elastomer, is deposited on the said backing layer;

a surface treatment is carried out on the coating layer;

patterns or decorations are printed; and

optionally, a protective varnish is deposited.

The printed coated textile according to the invention is described in greater detail below.

According to the invention, the term “printed” should be understood to mean that patterns or decorations are applied to the surface of the coating layer of the coated textile, in a discontinuous and varied manner, generally using inks of the modified polyurethane and/or acrylic type, as opposed to homogeneous coloration throughout the medium leading to relatively uniformly coloured materials.

The inventors have quite surprisingly discovered that, by applying a coating based on polyolefin components and on a polyolefin elastomer to a textile, patterns can then be printed by heliogravure.

The term “polyolefin component” should be understood to mean, according to the invention, an olefin polymer or copolymer or a blend of olefin polymers or copolymers, particularly thermoplastic olefin (TPO) polymers or copolymers such as, for example, polyethylene, polypropylene and blends or copolymers thereof.

According to the invention, the polyolefin component has a Shore A hardness ranging from 30 to 50, preferably 40 Shore A.

The coating layer also includes a component of the polyolefin elastomer type, preferably of the EPDM (ethylene-propylene-diene monomer) type.

The coating layer typically comprises 15 to 25 parts by weight (with respect to the total weight of the composition) of polyolefin component and 65 to 80 parts by weight of EPDM-type elastomer (with respect to the total weight of the composition).

Moreover, this coating layer may contain various additives, especially for improving/modifying the mechanical properties of the final printed coated textile, its UV resistance, etc., such as plasticizers, UV stabilizer, etc.

The composition of the coating layer is typically as indicated below:

| | | | |
|---|---|---|---|
| Polyolefin component | | | 15 to 25 parts by weight |
| EPDM-type elastomer | {close oversize brace} | A | 65 to 80 parts by weight |
| Paraffin oil | | | 0 to 15 parts by weight |
| Metallocene-low density | | | 10 to 30 parts by weight |
| Polyethylene | | | with respect to A |
| Polypropylene homopolymer | | | 5 to 8 parts by weight with |
| | | | respect to A |
| UV, heat stabilizer | | | 0.4 to 0.6 parts by weight |
| | | | with respect to A |

The textile layer forming a backing may comprise or consist of a woven, of a nonwoven or of a mesh, the woven and the nonwoven being preferred. The textile may equally well be a natural, an artificial or a synthetic textile.

According to another embodiment of the invention, the textile backing may be lined with a foam-rubber underlayer on its face on the opposite side from that bearing the coating.

The composition of the coating layer according to the invention makes it possible for it to be applied to the textile backing by calendering or extrusion. The coating is thus produced during this step.

In order to allow patterns to be printed on the aforementioned coated textile, a surface treatment is preferably carried out so as to promote the bonding and adhesion of the subsequent printing on the surface of the coating layer which is not bonded to the textile backing.

For this purpose, an electrical treatment may be carried out in order to make the printing surface of the coating layer, namely the surface of the coating layer which is not bonded to the textile, polar.

A chemical treatment may also be carried out by depositing a printing primer. This is of the type normally used prior to implementing the heliogravure technique. Generally, it is a varnish based on chlorinated polyolefins.

Depending on the case, one or other of these treatments is carried out or they are carried out in succession.

Next, the actual printing of the desired patterns, by heliogravure, is carried out on the surface thus prepared.

The heliogravure technique is employed in a conventional manner, generally with inks of the possibly modified polyurethane and/or acrylic type.

Next, the resulting printed coated textile may be protected by a varnish, especially an acrylic-type varnish. Depending on the desired effect, the protective varnish may be colourless or coloured, but translucent in order to reveal the printed pattern(s).

The printed coated textile according to the invention especially has great flexibility, as well as good resistance to ageing, to weather, to ultraviolet radiation and to food stains.

“Anti-stain” additives of known type may be introduced, for example into the final protective varnish, in order to increase the non-stainability of the coated textile, for example with respect to food stains.

The desired patterns may be printed with the equipment conventionally used in heliogravure printing.

The printing applied adheres well to the backing and exhibits good ageing resistance, especially when exposed to the weather, during washing, etc.

No sticky feel is found with use.

Moreover, the printed coated textile according to the invention is impermeable to liquids.

In addition, the composition of the coating layer does not contain halogenated compounds, thereby opening up the possibility of recycling the coated textile.

The invention also relates to articles containing a printed coated textile as mentioned above. It applies more particularly to the manufacture of printed coated tablecloths or other articles intended for tableware, or else articles intended for interior decoration, particularly wall textiles.

The invention will now be illustrated with the aid of an example which must not be regarded as limiting.

### EXAMPLE

The various phases in the production of a printed coated tablecloth are as follows:

1) Use of an emerized ecru cotton woven of 90 g/m² weight for the backing layer;

2) Calendering a TPO film wish a thickness of 0.013 mm onto the backing. Calendering temperature: 160° C.

Coating composition used:

| | | |
|---|---|---|
| thermoplastic polyolefin of 40 | 70 | parts by weight |
| Shore A hardness | | |
| elastomeric polyolefin | 25 | parts by weight |
| polypropylene homopolymer | 5 | parts by weight |
| Phosphate-type antioxydant | 0.2 | parts by weight |
| UV absorber | 0.1 | parts by weight |
| HALS-type UV stabilizer | 0.1 | parts by weight |

3) Corona electrical treatment in line with the calender, in order to obtain a surface tension of greater than 52 dynes/cm.

Wet deposition of 20 g/m² of a 5% chlorinated polypropylene solution using heliogravure (printing primer).

4) Heliogravure printing of a decoration in 1 to 6 colours with an acrylic-type ink. 5) Heliogravure varnishing using an acrylic-type varnish containing additives to make it non-staining. Deposition of 20 g/m² of a solution having a solids content of 15%. Drying at 80° C.

6) Embossing of the assembly at a temperature of 130° C. and a pressure of 20 bar.

1. Coated textile having printed patterns, characterized in that it comprises a textile underlayer forming a backing and combined with a coating layer formed from a film based on a polyolefin component and on an EPDM-type elastomer, the said coating layer having printed patterns on its surface which is not bonded to the textile underlayer.

2. Coated textile having printed patterns according to claim 1, characterized in that the polyolefin component has a Shore A hardness of between 30 and 50, preferably 40 Shore A.

3. Coated textile having printed patterns according to either of claims 1 and 2, characterized in that the polyolefin component consists of TPO-type polymers or copolymers chosen especially from polyethylene, polypropylene and blends or copolymers thereof.

4. Coated textile having printed patterns according to any one of claims 1 to 3, characterized in that the polyolefin component content is between 15 and 25 parts by weight with respect to the total weight of the composition.

5. Coated textile having printed patterns according to any one of claims 1 to 4, characterized in that the elastomer content is between 65 and 80 parts by weight.

6. Coated textile having printed patterns according to any one of claims 1 to 5, characterized in that the composition of the coating layer is as follows:

| | | | |
|---|---|---|---|
| Polyolefin component | | | 15 to 25 parts by weight |
| EPDM-type elastomer | {close oversize brace} | A | 65 to 80 parts by weight |
| Paraffin oil | | | 0 to 15 parts by weight |
| Metallocene-very low density | | | 10 to 30 parts with-respect |
| polyethylene | | | to A |
| Polypropylene homopolymer | | | 5 to 8 parts with respect |
| | | | to A |
| UV, heat stabilizer | | | 0.4 to 0.6 parts with |
| | | | respect to A |

7. Coated textile having printed patterns according to any one of claims 1 to 6, characterized in that the coated textile furthermore has a printing primer deposited on the coating layer.

8. Coated textile having printed patterns according to any one of claims 1 to 6, characterized in that it is provided with a protective varnish applied to the printed coating layer.

9. Coated textile having printed patterns according to any one of claims 1 to 8, characterized in that the underlayer forming a textile backing comprises or consists of a woven, a nonwoven or a mesh, preferably a woven or a nonwoven.

10. Coated textile having printed patterns according to any one of claims 1 to 9, characterized in that it is provided with a foam-rubber underlayer combined with the backing textile on its face on the opposite side from that bearing the coating.

11. Process for the production of a coated textile having printed patterns as defined according to any one of claims 1 to 10, characterized in that:
the process stares with a textile underlayer forming a backing;
a coating layer, based on a polyolefin component and on an elastomer, is deposited on the said backing layer;
a surface treatment is carried out on the coating layer;
the pattern(s) or decoration(s) is(are) printed; and
optionally, a protective varnish is deposited.

12. Process according to claim 11, characterized in that the coating layer is as defined in any one of claims 2 to 6.

13. Process according to either of claims 11 and 12, characterized in that the textile backing is of the woven, nonwoven or mesh, preferably woven or nonwoven, type.

14. Process according to any one of claims 11 to 13, characterized in that the textile backing is provided with a foam-rubber underlayer on its face on the opposite side from that to which the coating is applied.

15. Process according to any one of claims 11 to 14, characterized in that the coating layer is applied to the textile backing by calendering.

16. Process according to any one of claims 11 to 15, characterized in that the coating layer is applied to the textile backing by extrusion.

17. Process according to any one of claims 11 to 15, characterized in that the surface treatment comprises an electrical treatment and/or chemical deposition of a printing primer.

18. Process according to any one of claims 11 to 17, characterized in that the printing of the patterns/or decorations is carried out by heliogravure.

19. Articles comprising a coated textile having printed patterns according to any one of claims 1 to 18.

20. Articles according to claim 19, consisting of printed tablecloths.

21. Articles according to claim 19, consisting of printed wall textiles.
